(19) United States
(12) Patent Application Publication
(10) Pub. No.: US 2007/0290817 A1
(43) Pub. Date: Dec. 20, 2007

(54) Timing Pillow with Multiple Alerting Abilities

(76) Inventor: Yung-Ching Huang, Taipei City (TW)

Correspondence Address: WPAT, PC, 7225 BEVERLY ST., ANNANDALE, VA, 22003, US

(21) Appl. No.: 11/463,847

(22) Filed: Aug. 10, 2006

(30) Foreign Application Priority Data
Jun. 16, 2006 (TW) 095210503

(51) Int. Cl. G08B 1/00

(52) U.S. Cl. 340/309.16

(57) ABSTRACT

A timing pillow with multiple alerting abilities is disclosed, which is substantially a pillow having an accommodating space receiving a wireless receiving unit of a timing apparatus, the wireless receiving unit being arranged with various alerting devices therein while being enabled to receive signals of a wireless transmitting unit of the timing apparatus and generate a plurality of alerting signals accordingly. The wireless receiving unit is comprised of: a wireless receiving module, being enabled to receive a signal transmitted from a wireless transmitting module of the wireless transmitting unit while issuing an electrical signal accordingly; a controller, for issuing a control signal; an eccentric motor, being enabled to generate a action for producing a high frequency vibration with respect to the control signal; a timer, capable of providing an activating signal to the controller at a specific time for enabling the controller to issue the control signal to activate the eccentric motor; and a power source, for providing power to the aforesaid components.

### FIELD OF THE INVENTION

The present invention relates to a timing pillow with multiple alerting abilities, and more particularly, to a pillow having a timing apparatus with alerting/wireless receiving modules arranged therein. In a preferred aspect, since the wireless receiving module is enabled to communicate with a wireless transmitting unit in a wireless manner, as soon as a detector of the wireless transmitting unit is triggered to issue a detection signal, the detection signal is transmitted to the wireless receiving module of the timing apparatus for controlling a controller to activate an eccentric motor, both also being arranged in the pillow, to vibrate while using the vibration as an alerting signal to alert a user, who may be in sleep or dozing or who is hearing-impaired, with the triggering of the detector, and thus the situation that triggers the detector can be dealt with in time.

### BACKGROUND OF THE INVENTION

As the wireless communication technology is becoming commonplace, it is being implemented in devices ranged from the remote control of model cars to the communication devices of space satellite. The convenience that the wireless communication technology provides is present everywhere in our daily life, as it can free us from the trouble of cabling of various modern electronic devices, large and small.

For those hearing-impaired or hard of hearing, their awareness to danger might not as alert as ordinary person that the audio sound of alarm, commonly used everywhere, is not perceptible to them. It is obvious that you can not wake up a deaf by alarm clock without the assistant of a flash-light device or vibration device. However, most electronic devices, currently available on the market, are not designed and configured with alerting apparatuses for hearing-impaired. Therefore, it is required to have an apparatus capable of overcoming the aforesaid shortcomings and is suitable for hearing-impaired person.

Therefore, by designing a detector of a wireless transmitting unit to be able to detect a specific condition, such as baby crying, door knocking, or door-bell ringing, etc., and as a wireless receiving module of a timing apparatus with multiple alerting abilities is enabled to communicate with the wireless transmitting unit, as soon as a detector is triggered to issue a detection signal, the detection signal is transmitted to the wireless receiving module for controlling the timing apparatus, arranged in the pillow, to vibrate while using the vibration as an alerting signal to alert a user, who may be in sleep or dozing or who is hearing-impaired.

### SUMMARY OF THE INVENTION

In view of the disadvantages of prior art, the primary object of the present invention is to provide a timing pillow with multiple alerting abilities, which is substantially a pillow having a timing apparatus with alerting/wireless receiving modules arranged therein. By which, since the wireless receiving module is enabled to communicate with a wireless transmitting unit in a wireless manner, as soon as a detector of the wireless transmitting unit is triggered to issue a detection signal, the detection signal is transmitted to the wireless receiving module of the timing apparatus for controlling a controller to activate an eccentric motor, both also being arranged in the pillow, to vibrate while using the vibration as an alerting signal to alert a user, who may be in sleep or dozing or who is hearing-impaired, with the triggering of the detector, and thus the situation that triggers the detector can be dealt with in time.

It is another object of the invention to provide a pillow having a timer arranged therein, by which the timer issue an activating signal at a specific time for enabling an eccentric motor to vibrate while bringing along the pillow to vibrate as well, and thus a user holding the pillow can be reminded to accomplish a work scheduled by the timer.

Yet, another object of the invention to provide a timing pillow with multiple alerting abilities, in which a detector of a wireless transmitting unit is designed to detect a specific condition, such as baby crying, door knocking, or door-bell ringing, etc., and as a wireless receiving module of the timing pillow with multiple alerting abilities is enabled to communicate with the wireless transmitting unit, as soon as a detector is triggered to issue a detection signal, the detection signal is transmitted to the wireless receiving module for controlling the timing apparatus, arranged in the pillow, to vibrate while using the vibration as an alerting signal to alert a user, who may be in sleep or dozing or who is hearing-impaired.

To achieve the above objects, the present invention provides a timing pillow with multiple alerting abilities, being substantially a pillow having an accommodating space receiving a wireless receiving unit of a timing apparatus, the wireless receiving unit being arranged with various alerting devices therein while being enabled to receive signals of a wireless transmitting unit of the timing apparatus and generate a plurality of alerting signals accordingly, the wireless receiving unit comprising: a wireless receiving module, being enabled to receive a signal transmitted from a wireless transmitting module of the wireless transmitting unit while issuing an electrical signal accordingly; a controller, for issuing a control signal; an eccentric motor, being enabled to generate a action for producing a high frequency vibration with respect to the control signal; a timer, capable of providing an activating signal to the controller at a specific time for enabling the controller to issue the control signal to activate the eccentric motor; and a power source, for providing power to the aforesaid components.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a perspective view of a timing pillow with multiple alerting abilities according to the present invention.

FIG. 2 is a function block diagram illustrating a wireless receiving unit of a timing apparatus with multiple alerting abilities according to the present invention.

FIG. 3 is a function block diagram illustrating a wireless transmitting unit of a timing apparatus with multiple alerting abilities according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

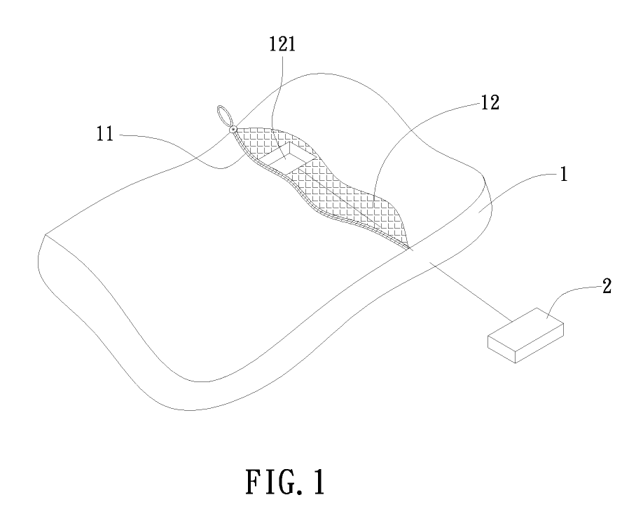

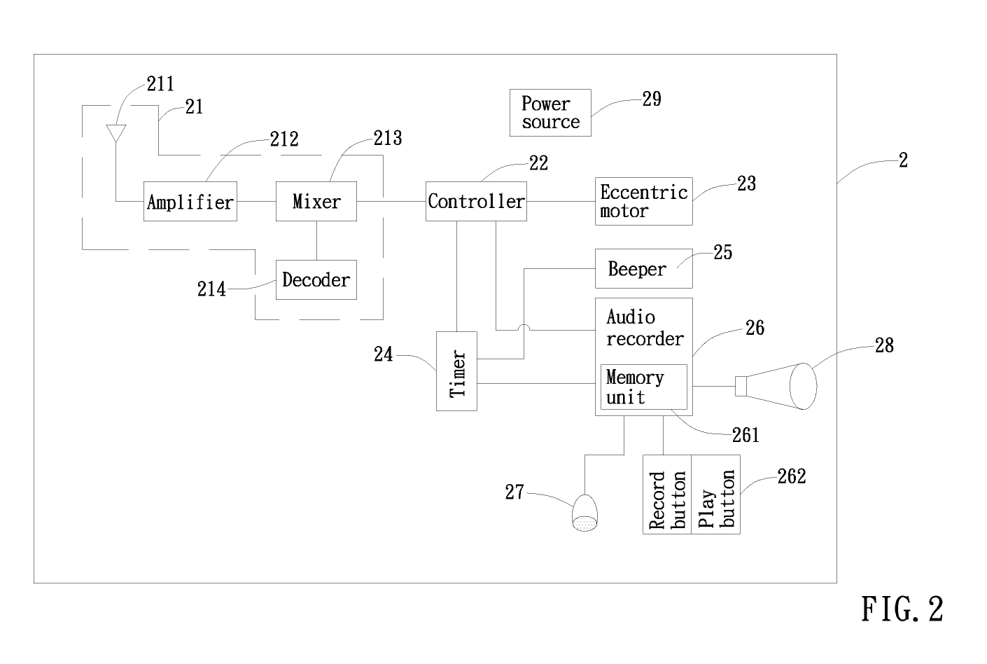

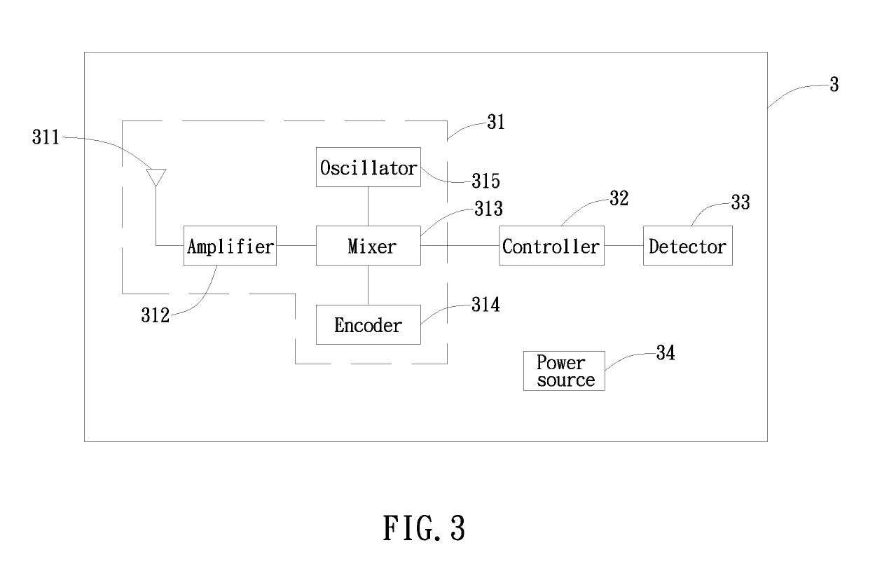

Please refer to FIG. 1, which is a perspective view of a timing pillow with multiple alerting abilities according to the present invention. In FIG. 1, the timing pillow with multiple alerting abilities is substantially a pillow 1 having an accommodating space 121 receiving a wireless receiving unit 2 (shown in FIG. 2) of a timing apparatus. It is noted that the pillow 1 can be just an ordinary pillow, that it can be made of sponge 12 or foam rubber, and formed into any shape at will. Moreover, a zipper 11 can be install in the pillow in a manner that the accommodating space 121 can be revealed as soon as the zipper 11 is unzipped. Although the wireless receiving unit 2 is embedded in the sponge 12 of the pillow 1, the comfort of the pillow 1 is still satisfactory since the sponge of the pillow 1 is thick enough that a user hugging the pillow 1 will not even feel the existence of the wireless receiving unit 2. Since the wireless receiving unit 2 is enabled to communicate with a wireless transmitting unit 3 (shown in FIG. 3), as soon as a detector 33 of the wireless transmitting unit 3 is triggered to issue a detection signal, the detection signal is transmitted to the wireless receiving unit 2 of the timing apparatus for activating an eccentric motor 23 to vibrate while using the vibration as an alerting signal to alert a user, who may be in sleep or dozing or who is hearing-impaired, with the triggering of the detector 33, and thus the situation that triggers the detector 33 can be dealt with in time. However, the wireless receiving unit 2 can be embedded in objects like cushion, and is not limited itself to the aforesaid pillow 1.

Please refer to FIG. 2, which is a function block diagram illustrating a wireless receiving unit of a timing apparatus with multiple alerting abilities according to the present invention. As seen in FIG. 2, the wireless receiving unit 2 is comprised of: a wireless receiving module 21, composed of an antenna 211, an amplifier 212, a mixer 213 and a decoder 214, capable of receiving a signal transmitted from the wireless transmitting unit 3 and thus issuing an electrical signal accordingly; a controller 22, for generating a control signal; an eccentric motor 23, being enabled to generate a action for producing a high frequency vibration with respect to the control signal; a timer 24, capable of providing an activating signal to the controller 22 at a specific time for enabling the controller 22 to issue the control signal to activate the eccentric motor 23; and a power source 29, for providing direct current to the aforesaid components; wherein, the power source 29 can be a plurality of serial-connected batteries, that can be easily replaced as the batteries run dry, or can be a socket capable of connecting directly to an indoor power source through an external voltage transformer, or even can be a socket connecting capable of connecting to a lighter socket of an automobile by a cable. In a preferred aspect, the wireless receiving unit 2 further comprises an audio recorder 26 and a loudspeaker 28, capable of cooperatively playing a pre-recorded alarm sound, wherein the audio recorder 26, having a record button and a play button arranged therein, is comprised of a memory unit 261 and a microphone 27. The audio recorder 26 can be used for recording a vocal sound of alerting, such as a mother's gentle wake-up call, that the vocal sound can last about 8 seconds to 20 seconds, depending on the capacity of the memory unit 261. In addition, the wireless receiving unit 2 further comprises a beeper 25, for issuing an alerting sound, such as a beeping sound, or a sound of ring-bell. Obviously, the function of the aforesaid timer 24 and the beeper 25 can easily be replaced by a common alarm clock, and thus can be removed from the circuitry of the wireless receiving unit 2.

In a preferred embodiment of the invention, the wireless receiving module 21 is removed from the timing pillow with multiple alerting abilities, and thus the wireless transmitting unit 3 is also eliminated, such that the pillow 1 is just a timing/alerting apparatus without the ability of remote detection and wireless transmission. Operationally, the timing/alerting pillow can be scheduled to activate the eccentric motor 23 to vibrate or to activate the beeper 25 to beep, while using the vibration or the beeping as an alerting signal to alert a user, who may be in sleep or dozing or who is hearing-impaired. By removing the remote detection and wireless transmission devices from the timing pillow of the invention, the manufacturing cost is reduce and thus the timing pillow can be sell at a cheaper price. The aforesaid simplified timing pillow is primarily comprised of: a controller 22, an eccentric motor 23, a timer 24 and a power source. In a preferred aspect, the simplified timing pillow can further comprise those other relating devices for generating alarm sounds, as the beeper 25 and audio recorder 26 shown in FIG. 2.

Please refer to FIG. 3, which is a function block diagram illustrating a wireless transmitting unit of a timing apparatus with multiple alerting abilities according to the present invention. The wireless transmitting unit 3 of FIG. 3 is comprised of: a wireless transmitting module 31, a controller 32, a detector 33, and a power source 34; wherein the wireless transmitting module 31 further comprises an antenna 311, an amplifier 312, an oscillator 313, a mixer 313 and an encoder 314. In a preferred aspect, the detector 33 can be a device selected from the group consisting of an audio detector, a reed sensor, a gas alarm, and a fire alarm, or a combo device integrating at least two devices selected from the forgoing group, that the detector can be used for detecting various events, such as baby crying, burglar breaking-in, gas leaking, fire, etc. It is noted that the detection device listed in the aforesaid group is not for illustration that the detector 33 can be any household detection apparatus and is not limited thereby.

Moreover, the radio frequency adopted by the wireless receiving module 21 and the wireless transmitting module 31 for enabling communication between the two is a frequency band selected from the group consisting of 315 MHz and 433.92 MHz, whereas the former is fitted for US and Taiwan communication specifications while the later is fitted for Europe, US and Taiwan communication specifications that both are common RF bands and are safe for human health.

To sum up, as seen in FIG. 2 and FIG. 3, the timing pillow with multiple alerting abilities of the invention is substantially a pillow having a timing apparatus with alerting/wireless receiving modules arranged therein. By which, since the wireless receiving module is enabled to communicate with a wireless transmitting unit in a wireless manner, as soon as a detector of the wireless transmitting unit is triggered to issue a detection signal, the detection signal is transmitted to the wireless receiving module of the timing apparatus for controlling a controller to activate an eccentric motor, both also being arranged in the pillow, to vibrate while using the vibration as an alerting signal to alert a user, who may be in sleep or dozing or who is hearing-impaired, with the triggering of the detector, and thus the situation that triggers the detector can be dealt with in time. In addition, a timer can be added in the circuitry of the timing apparatus, such that a user can be waked up at a scheduled time after he/she is dozing for a while. Moreover, As the detector of a wireless transmitting unit is designed to detect a specific condition, such as baby crying, door knocking, or door-bell ringing, etc., and as a wireless receiving module of the timing pillow with multiple alerting abilities is enabled to communicate with the wireless transmitting unit, as soon as a detector is triggered to issue a detection signal, the detection signal is transmitted to the wireless receiving module for controlling the timing apparatus, arranged in the pillow, to vibrate while using the vibration as an alerting signal to alert a user, who may be in sleep or dozing or who is hearing-impaired.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A timing pillow with multiple alerting abilities, being substantially a pillow having an accommodating space receiving a wireless receiving unit of a timing apparatus, the wireless receiving unit being arranged with various alerting devices therein while being enabled to receive signals of a wireless transmitting unit of the timing apparatus and generate a plurality of alerting signals accordingly, the wireless receiving unit comprising:
a wireless receiving module, being enabled to receive a signal transmitted from a wireless transmitting module of the wireless transmitting unit while issuing an electrical signal accordingly;
a controller, for issuing a control signal;
an eccentric motor, being enabled to generate a action for producing a high frequency vibration with respect to the control signal;
a timer, capable of providing an activating signal to the controller at a specific time for enabling the controller to issue the control signal to activate the eccentric motor; and
a power source, for providing power to the aforesaid components.

2. The timing pillow of claim 1, further comprising an audio recorder and a loudspeaker, capable of cooperatively playing a pre-recorded alarm sound.

3. The timing pillow of claim 2, wherein the audio recorder further comprises a memory unit and a microphone.

4. The timing pillow of claim 3, wherein the memory unit is able to store audio data capable of being played about 8 seconds to 20 seconds.

5. The timing pillow of claim 2, wherein the audio recorder further comprises a record button and a play button.

6. The timing pillow of claim 1, further comprises a beeper and a loudspeaker, for providing an alarm sound.

7. The timing pillow of claim 1, wherein the wireless receiving module is comprised of an antenna, an amplifier, a mixer, and a decoder.

8. The timing pillow of claim 1, wherein the power source is a plurality of serial-connected batteries.

9. The timing pillow of claim 1, wherein the power source is substantially a socket capable of connecting directly to an indoor power source through an external voltage transformer.

10. The timing pillow of claim 1, wherein the power source is substantially a socket connecting capable of connecting to a lighter socket of an automobile by a cable.

11. The timing pillow of claim 1, wherein the wireless transmitting unit further comprises an antenna, a wireless transmitting module, a detector, a controller, and a power source.

12. The timing pillow of claim 11, wherein the wireless transmitting module further comprises an amplifier, an oscillator, a mixer, and an encoder.

13. The timing pillow of claim 1, wherein the detector is a device selected from the group consisting of an audio detector, a reed sensor, a gas alarm, and a fire alarm.

14. The timing pillow of claim 1, wherein the radio frequency adopted by the wireless receiving module and the wireless transmitting module for enabling communication between the two is a frequency band selected from the group consisting of 315 MHz and 433.92 MHz.

15. A timing pillow with multiple alerting abilities, being substantially a pillow having an accommodating space receiving a timing apparatus, with multiple alerting abilities, comprising:
a controller, for issuing a control signal;
an eccentric motor, being enabled to generate a action for producing a high frequency vibration with respect to the control signal;
a timer, capable of providing an activating signal to the controller at a specific time for enabling the controller to issue the control signal to activate the eccentric motor; and
a power source, for providing power to the aforesaid components.

16. The timing pillow of claim 15, further comprises a beeper and a loudspeaker, for providing an alarm sound.

17. The timing pillow of claim 15, wherein further comprising an audio recorder and a loudspeaker, capable of cooperatively playing a pre-recorded alarm sound.

18. The timing pillow of claim 17, wherein the audio recorder further comprises a memory unit and a microphone.

19. The timing pillow of claim 18, wherein the memory unit is able to store audio data capable of being played about 8 seconds to 20 seconds.

20. The timing pillow of claim 15, wherein the power source is a plurality of serial-connected batteries.

21. The timing pillow of claim 15, wherein the power source is substantially a socket capable of connecting directly to an indoor power source through an external voltage transformer.

22. The timing pillow of claim 15, wherein the power source is substantially a socket connecting capable of connecting to a lighter socket of an automobile by a cable.
